(19) United States
(12) Patent Application Publication
(10) Pub. No.: US 2007/0092325 A1
(43) Pub. Date: Apr. 26, 2007

(54) Hand-held printing device

(76) Inventors: Anthony D. Studer, Albany, OR (US); Kevin D. Almen, Albany, OR (US); Gary G. Lutnesky, Corvallis, OR (US); Kevin E. Swier, Albany, OR (US); Sang O. Bradley, Corvallis, OR (US); Raymon Dale Burrows, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/256,402

(22) Filed: Oct. 21, 2005

(51) Int. Cl. B41J 3/36

(52) U.S. Cl. 400/88

(57) ABSTRACT

A hand-held printing device has a hand-operated mechanical actuator for moving a print head that prints images to medium and memory configured electronically storing a sequence of images in a predetermined sequential order. The hand-held printing device further has logic that detects a first actuation of the actuator and automatically communicates a first image in the sequence to the print head and detects a second actuation of the actuator and automatically communicates a second image in the sequence to the print head.

### RELATED ART

A typical hand-held, self-contained printing device comprises a housing and an actuator. A user manually positions the housing on a medium, and actuates the actuator. When the printing device is actuated, an image is printed to the medium.

Hand-held printing devices are often used to print images to media for which a conventional printer may not be desired. For example, a hand-held printing device may be used to print a series of recipient images to a plurality of envelopes. As another example, a hand-held printing device may be used to print a signature image to a plurality of letters.

Oftentimes, the user desires to repeat a sequence of images on like media. For example, the user may desire to print a return address and a recipient address on an envelope and repeat this sequence for other envelopes. Unfortunately, repetitive printing of a particular sequence of data, e.g., a return address and a plurality of recipient addresses, can be laborious with existing hand-held printing devices.

For example, to print a recipient address on an envelope, the user may select a recipient address, position the hand-held printing device, and actuate the actuator. To print another envelope, the user may then select another recipient address, reposition the hand-held printing device on another envelope, and again actuate the actuator. If the user desires to print a plurality of envelopes with varying recipient addresses, the user may also select the return address for each envelope. The user may repeat the sequence on a plurality of envelopes, and with each envelope, the user may select the image to be printed prior to actuation. Thus, for each image on each envelope the user usually selects the image for printing, positions the hand-held printing device, and actuates the actuator.

### SUMMARY OF THE DISCLOSURE

Generally, the present disclosure provides a hand-held device and method for printing data sequences.

A hand-held printing device in accordance with an embodiment of the present disclosure comprises a hand-operated mechanical actuator for moving a print head that prints images to a medium and memory configured to electronically store a sequence of images in a predetermined sequential order. The hand-held printing device further has logic that detects a first actuation of the actuator and automatically communicates a first image in the sequence to the print head and detects a second actuation of the actuator and automatically communicates a second image in the sequence to the print head.

A method in accordance with an exemplary embodiment of the present disclosure comprises receiving an input indicative of a first sequence of images to be printed in a predetermined sequential order and detecting a first manual actuation of a hand-operated actuator. The method further comprises printing a first image of the first sequence to a medium in response to the detecting of the first actuation, detecting a second manual actuation of the hand-operated actuator, and printing a second image of the first sequence to the medium in response to the detecting of the second actuation.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A is a block diagram illustrating an embodiment of a hand-held printing device in accordance with an exemplary embodiment of the present disclosure.

FIG. 1B is a block diagram illustrating another embodiment of a hand-held printing device in accordance with an exemplary embodiment of the present disclosure.

FIG. 2 is a block diagram of an exemplary sequence for use with the hand-held device depicted in FIG. 1A.

FIG. 3 is a block diagram of an exemplary sequence for use with the hand-held device depicted in FIG. 1A.

FIG. 4 is a block diagram of an exemplary hand-held printing device as depicted in FIG. 1A.

FIG. 5 is a block diagram of an exemplary interface of a hand-held printing device of FIG. 1A.

FIG. 6 is a block diagram of an exemplary interface of a hand-held printing device of FIG. 1A.

FIG. 7 is a block diagram of an exemplary interface of a hand-held printing device of FIG. 1A.

FIG. 8 is a block diagram of an exemplary interface of a hand-held printing device of FIG. 1A.

FIG. 9 is a block diagram of an exemplary interface of a hand-held printing device of FIG. 1A.

FIG. 10 is a block diagram of an exemplary interface of a hand-held printing device of FIG. 1A.

FIG. 11 is a block diagram of an exemplary interface of a hand-held printing device of FIG. 1A.

FIG. 12 is a block diagram of an exemplary interface of a hand-held printing device of FIG. 1A.

FIG. 13 is a block diagram of an exemplary interface of a hand-held printing device of FIG. 1A.

FIG. 14 is a block diagram of an exemplary interface of a hand-held printing device of FIG. 1A.

FIG. 15 is a block diagram of an exemplary interface of a hand-held printing device of FIG. 1A.

FIG. 16 is a block diagram of an exemplary interface of a hand-held printing device of FIG. 1A.

FIG. 17 is a flow chart illustrating an exemplary architecture and functionality of the sequencing logic depicted in FIG. 1A.

FIG. 18 is a block diagram of an exemplary interface of a hand-held printing device of FIG. 1A.

FIG. 19 is a block diagram of an exemplary interface of a hand-held printing device of FIG. 1A.

FIG. 20 is a block diagram of an exemplary interface of a hand-held printing device of FIG. 1A.

FIG. 21 is a block diagram of an exemplary interface of a hand-held printing device of FIG. 1A.

### DETAILED DESCRIPTION

Embodiments of the present disclosure generally pertain to hand-held printing devices and methods.

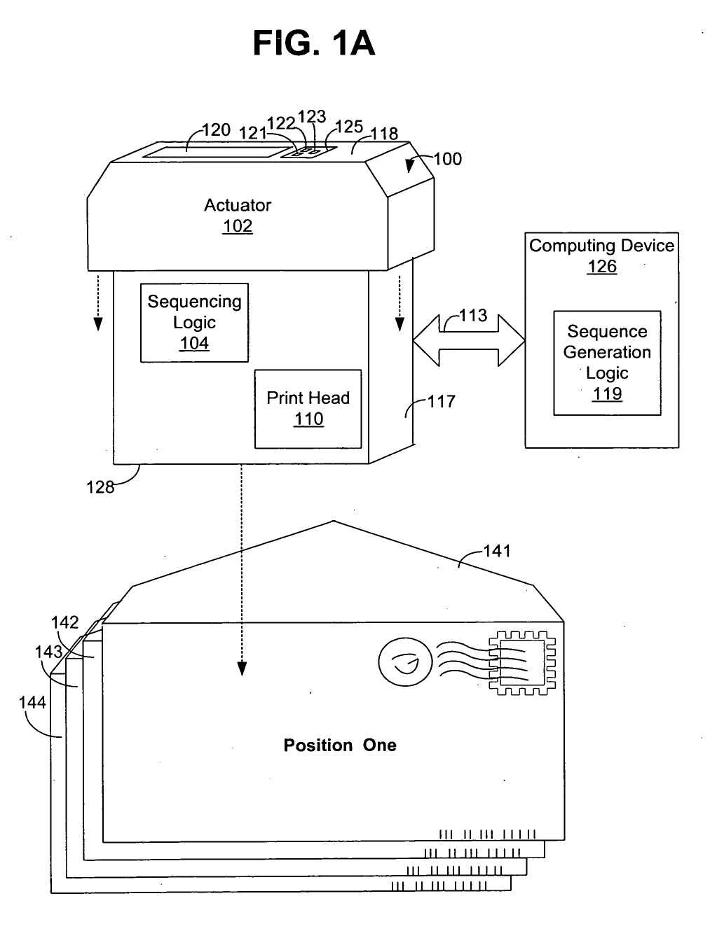

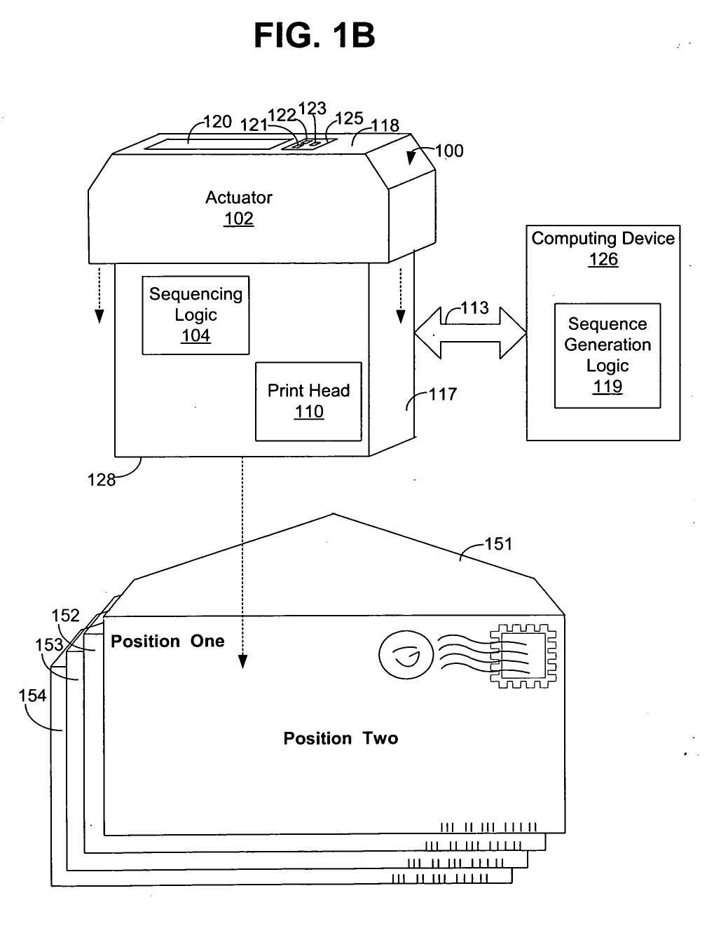

FIG. 1A depicts a hand-held printing device 100 in accordance with an exemplary embodiment of the present disclosure. The hand-held printing device 100 comprises a case 117 and an actuator 102. The case 117 has an aperture (not shown) at an end 128 opposing the actuator 102.

During normal operation, a user (not shown) manually positions the end 128 of the hand-held printing device 100 adjacent a print medium, e.g., an envelope, a box, or a piece of paper, at a position on the medium where the user desires to print an image. Note that FIG. 1A depicts a plurality of envelopes 141-144 as media on which a user might desire to print selected images. In this regard, the user might desire to print a recipient address at “Position One” on each of the envelopes 141-144, for example. Note that envelopes 141-144 are depicted as desired media for exemplary purposes only, and the hand-held printing device 100 can be used to print images on other types of media including, but not limited to boxes, letters, and the like. Additionally, a one-position sequence is used for exemplary purposes, but any practical number of positions could be defined in the device and logic.

Furthermore, as described further herein, an exemplary printing device 100 may be configured to sequentially print a predefined list of varying images. However, the predefined list of varying images is described herein for exemplary purposes. In this regard, the printing device 100 may further enable a user to sequentially vary characteristics, e.g., font or justification, of images.

The hand-held printing device 100 comprises an actuator 102 and a print head 110. Note that the actuator 102 can be any type of device known or future-developed, including a mechanical and/or electronic actuator that activates the print head 110. Further note that the print head 110 can be any known or future-developed device for transferring an image to the desired medium. For example, the print head 110 may be a thermal ink jet (TIJ), a piezoelectric, or thermal print engine, and printing is effectuated by transmitting an image to the print head.

In other embodiments, the actuator 102 may be activated via an electronic device (not shown), e.g., a button, and the user may initiate the printing motion manually. In this regard, the device 100 may comprise, for example, rollers (not shown). The user may actuate the electronic button and manually move the device 100 over a printing area, e.g., “Position One.” As the device 100 is manually moved over the printing area, the image is printing to the envelope 141.

The user manually positions the end 128 of the hand-held printing device 100 adjacent the desired envelope 141 at a desired position, e.g., “Position One.” Once the user has manually positioned the end 128 of the hand-held printing device 100 at a desired position adjacent the envelope 141, the user applies a manual force to the actuator 102, which causes the print head 110 to print a desired image onto the envelope 141 at the position manually selected by the user.

Note that while a manual actuator 102 is shown in FIG. 1A, other types of actuators 102 in other embodiments are possible. For example, the print head 110 may be activated via an electronic device, e.g., via a button (not shown), located on the hand-held printing device 100. In this regard, the actuator 102 may comprise a surface 118, and such surface may comprise a button (not shown) for activating the print head 110. Likewise, the print head 110 could be controlled by any number of methods such as, but not limited to, manual force, stored energy, or electronic means.

During operation, the user may desire to use the hand-held printing device 100 to print a sequence of images on a medium. For example, the user may desire to print a plurality of distinct recipient addresses on a plurality of envelopes. In another example, the user may desire to print a plurality of distinct recipient addresses and a return address on each envelope, which is described in more detail with reference to FIG. 1B. Note that in such an example, the return address for each envelope may remain static and the recipient address may vary for each envelope.

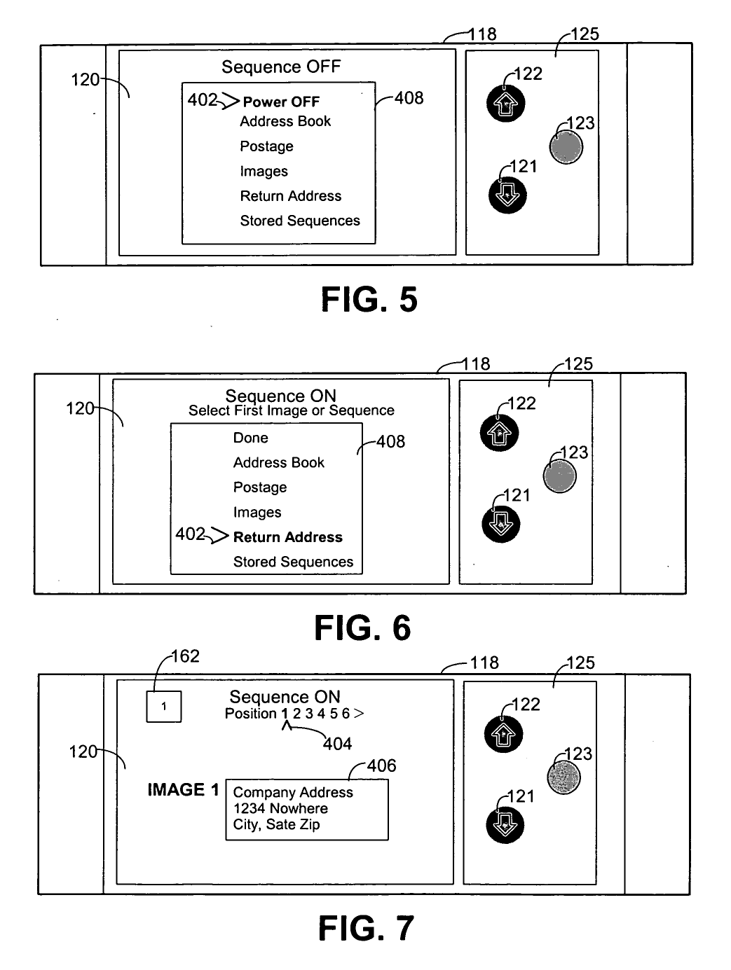

Thus, the hand-held printing device 100 further comprises sequencing logic 104 that enables a user to define a sequence via an input device 125. Note that the input device 125 shown in FIG. 1A is a keypad comprising a plurality of buttons 121-123, however, other input devices in other embodiments are possible. Further, the hand-held printing device 100 comprises a display device 120 for displaying information to the user when defining the sequence, which is described further herein with reference to FIGS. 5-15.

Generally, the user provides a plurality of images that the user may desire to print to an envelope 141. Such images may be transmitted via a connection 113 to a computing device 126 and may include, for example, text images, tagged image file format (TIFF) images, bitmap images, or other type of images created with other types of formats known in the art or future developed. Images may include but are not limited to addresses, names, postage stamps, logos, emoticons, and signatures, titles, and social security numbers.

When defining a sequence of images for printing to envelopes 141-144, the user may select, from data resident on the hand-held printing device 100, particular images that the user desires to print to the particular medium. For example, the user may desire to print a distinct recipient address image at “Position One” on each of the plurality of envelopes 141-144. In another example, the user may desire to print a particular return address image and a recipient address on the envelopes 141-144, which is described in more detail with reference to FIG. 1B.

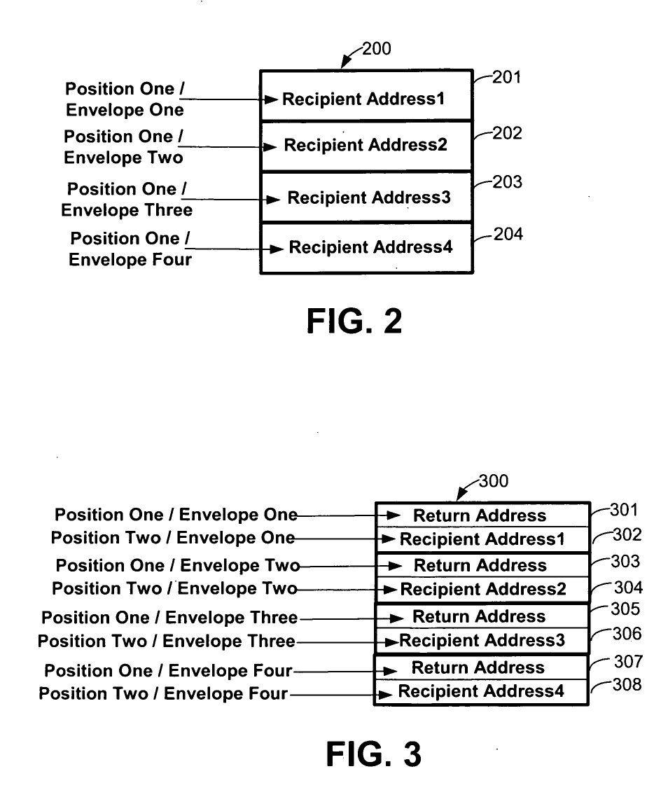

When defining a sequence, the user selects the desired images such that the sequence defined reflects the order in which the user anticipates manually positioning the device 100 for printing the images. For example, FIG. 2 depicts an exemplary sequence 200 wherein a distinct image is printed to each envelope at a manually selected “Position One” on each envelope 141-144. The sequence 200 comprises recipient address1 image at a location 201 in the sequence 200 for envelope 141, recipient address2 image at a location 202 for envelope 142, recipient address3 image at a location 203 for envelope 143, and recipient address4 image at a location 204 for envelope 144. While the exemplary sequence 200 selected by the user comprise a total of four images, such a number is for exemplary purposes only.

Once the user defines a sequence, e.g., sequence 200, the user may then select the sequence for printing via the input device 125. Once the user selects the defined sequence for printing, the sequencing logic 104 may display the first image in the sequence selected for printing and remain idle until the sequencing logic 104 detects actuation of the actuator 102. Thereafter, the user manually positions the end 128 of the hand-held printing device 100 on the envelope 141 and actuates the actuator 102.

Once the user has selected a sequence for printing, the sequencing logic 104 displays the first image in the sequence to the display device 120. When the sequencing logic 104 detects actuation of the actuator 102, the sequencing logic 104 communicates the first image in the sequence to the print head 110. The print head 110 prints the first image to the medium at the position on the medium manually selected by the user. The sequencing logic 104 displays the next image in the sequence for printing to the display device 120. The user may then reposition the end 128 of the device 100 onto another medium or at a different position on the medium and actuate the actuator 102. When the sequencing logic 104 detects the second actuation of actuator 102, the sequencing logic 104 communicates the currently displayed second image to the print head 110, which prints the second image to the second position on the medium manually selected by the user. Such process continues until each image in the selected sequence has been printed to the media.

During the described process, the user may visually inspect each of the printed images prior to printing a next image to ensure that the image was properly transferred to the medium. Alternatively, the user may print an entire sequence of images then visually inspect each of the printed images to ensure that the images were properly transferred to the medium. If the user discovers an error in one of the images, e.g., the quality is not good or the incorrect image has been printed, the user may then scroll through the list of images associated with the sequence to locate the image printed in error. In this regard, the user may scroll forward through the list or backward. The user may reselect the image that has been incorrectly printed and reprint the image, or the user may reprint the remaining images in the sequence.

In the example provided by FIG. 2, the user selects the sequence 200 via the input device 125 (FIG. 1A). The user manually positions the end 128 of the printing device 100 (FIG. 1A) at “Position One” indicated on envelope 141 (FIG. 1A). The user actuates the actuator 102, and the sequencing logic 104 detects the actuation. The sequencing logic 104 then communicates “Recipient Address1” at location 201 in the sequence to the print head 110, and the print head 110 prints the image to “Position One” on envelope 141. The user moves the device 100 to the next envelope 142 and manually positions the end 128 of the printing device 100 (FIG. 1A) at “Position One” (not shown) of envelope 142 (FIG. 1A). The user actuates the actuator 102, and the sequencing logic 104 detects the actuation. The sequencing logic 104 then communicates “Recipient Address2” at location 202 in the sequence 200 to the print head 110, and the print head 110 prints the image to “Position One” on envelope 142. The user continues to actuate the actuator 102 with respect to each envelope 141-144 until each of the recipient addresses at each location 201-203 in the sequence 200 are communicated to the print head 110 and printed to each envelope 141-144 in sequential order. Note that the envelopes 142-144 are not specifically shown. However, for the present example, each additional envelope 142-144 is identical to envelope 141 having a “Position One” at the position indicated on envelope 141.

Notably, the user is able to print each of the images within the defined sequence 200 without manually selecting a new image when the image changes. Thus, the user may proceed to each envelope in the example, manually position the end 128, and actuate the actuator 102 without affirmatively selecting a new image for printing.

FIG. 1B illustrates another embodiment of the printing device 100. In such an embodiment, the user may define a two-position sequence. In such an example, the user may desire to print a plurality of distinct recipient addresses and a return address on each envelope. In this regard, the user may desire to print a return address at “Position One” and a recipient address at “Position Two” on each envelope. Note that in such an example, the return address for each envelope remains static and the recipient address varies for each envelope.

In such an example, the sequencing logic 104 enables a user to define a sequence via an input device 125 having a plurality of positions, e.g., “Position One” and “Position Two.” When defining a sequence of images for printing to envelopes 151-154, the user may select, from data resident on the hand-held printing device 100, particular images that the user desires to print to the particular medium, as described hereinabove. For example, the user may desire to print a return address image at “Position One” on each of the plurality of envelopes 151-154 and a distinct recipient address at “Position Two” on each of the envelopes 151-154

As described hereinabove, when defining a sequence, the user selects the desired images and associates the desired images to reflect the sequential order in which the user anticipates manually positioning the device 100 for printing the images.

In this regard, FIG. 3 depicts an exemplary sequence 300. In such a sequence, the user defines a distinct image that is to be printed to each envelope at a manually selected “Position One” and “Position Two” for each envelope 151-154.

In such a sequence 300, the user desires to print a return address at “Position One” and a distinct recipient address at “Position Two” on each of the plurality of envelopes 151-154. As described hereinabove, the user defines the sequence 300 via the input device 125 (FIG. 1B), then selects the sequence 300 for printing.

Once the sequence 300 is selected for printing, the user manually positions the end 128 of the printing device 100 (FIG. 1B) at “Position One” indicated on the first envelope 151 (FIG. 1B). The user actuates the actuator 102, and the sequencing logic 104 detects actuation. The sequencing logic 104 then communicates the “Return Address” image at location 301 to the print head 110. The print head 110 prints the “Return Address” at location 301 to “Position One” on envelope 151. The user then manually positions the device 100 at “Position Two” on envelope 151. When the user actuates the actuator 102 at “Position Two,” the sequencing logic 104 detects actuation and communicates the next image, “Recipient Address1” at location 302, to the print head 110. The print head 110 prints the image at location 302 to envelope 151 at “Position Two.”

The user then continues to the next envelope 152 and manually positions the end 128 of the printing device 100 (FIG. 1B) at “Position One” (not shown) of the second envelope 152 (FIG. 1B). The user actuates the actuator 102, and the sequencing logic 104 detects actuation. The sequencing logic 104 communicates the “Return Address” at location 303 in the sequence 300 to the print head 110. The print head 110 prints the image at location 303 to “Position One” on envelope 152. The user continues to actuate the actuator 102 with respect to each position on each envelope 151-154 until each return address from locations 301, 303, 305, and 307 in the sequence 300 and each recipient address from each location 302, 304, 306, and 308 in the sequence 300 are communicated to the print head 110 and printed to each envelope 151-154.

With reference to FIGS. 1A and 1B, in one embodiment, the hand-held device 100 prints independently of the computing device 126. However, in other embodiments, the hand-held device 100 may be communicatively coupled to the computing device, e.g., via a universal serial bus (USB) or via a wireless connection. In such an embodiment, the images defining a sequence may be stored in memory (not shown) of the computing device 126, and the computing device 126 may transfer data to the hand-held device 100 upon actuation of the actuator 102.

Notably, the user is able to print each of the images within the defined sequence 300 without manually selecting a new image when the image changes. Thus, the user may proceed to each position on each envelope and to each envelope in the example, manually position the end 128 of the printing device 100, and communicate the image to the print head 110 without affirmatively selecting a new image for printing.

As described hereinabove, the device 100 may interface via the connection 113 with the computing device 126. The computing device 126 may further comprise sequence generation logic 119. Note that the sequence generation logic 119 can be software, hardware, or a combination thereof, Thus, in one embodiment of the hand-held printing device 100, the user of the computing device can use the sequence generation logic 119 to create sequences, e.g., sequence 200 (FIG. 2) or sequence 300 (FIG. 3), for use with the hand-held printing device 100. Such generated sequences may be transmitted to the hand-held device 100 and stored on the device 100 or printed as described herein upon actuation.

After generating sequences, the user may transmit data indicative of the sequences to the hand-held printing device 100 via the connection 113. The connection 113 may be a universal serial bus (USB) connection, a radio frequency (RF) connection, or other wireless connection.

Furthermore, the user may transmit images for use in generated sequences via the connection 113. For example, the user may desire to create a mailing list comprising a plurality of customers. The user may generate such a list on the computing device 126 and transmit the list to the hand-held printing device 100 for use in a sequence created on the hand-held printing device 100, as described hereinabove.

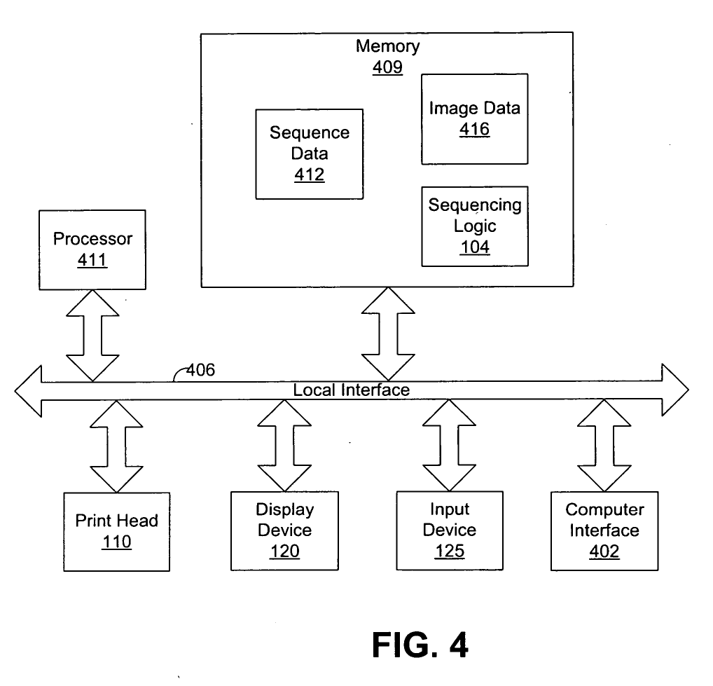

It should be noted that the sequencing logic 104 can be implemented in software, hardware, or a combination thereof. In an exemplary embodiment illustrated in FIG. 4, the sequencing logic 104, along with its associated methodology, is implemented in software and stored in memory 409 of the hand-held printing device 100. Furthermore, the device 100 comprises image data 416 and sequence data 412, each of which is described further herein.

Note that the sequencing logic 104, when implemented in software, can be stored and transported alone, or in combination with sequence data 412 and image data 416, on any computer-readable medium for use by or in connection with an instruction execution system, apparatus, or device, such as a computer-based system, processor-containing system, or other system that can fetch and execute instructions. In the context of this document, a “computer-readable medium” can be any means that can contain, store, communicate, propagate, or transport a program for use by or in connection with the instruction execution system, apparatus, or device. The computer readable-medium can be, for example but not limited to, an electronic, magnetic, optical, electromagnetic, infrared, or semiconductor system, apparatus, device, or propagation medium.

The exemplary embodiment of the hand-held printer depicted by FIG. 4 comprises at least one processing element 411, such as a digital signal processor (DSP) or a central processing unit (CPU), that communicates to and drives the other elements within the hand-held printing device 100 via a local interface 406, which can include at least one bus.

As described hereinabove with reference to FIGS. 1A and 1B, the hand-held printing device 100 comprises the input device 125. The input device 125 can be, for example, a keypad having a plurality of buttons 121-123. Further, the hand-held printing device 100, as described hereinabove, preferably comprises the display device 120, which can be used to output data to the user.

During operation of the hand-held printing device 100, a user activates the sequencing logic 104 via the input device 125. In this regard, the user may select a button 121-123 (FIGS. 1A and 1B) or series of buttons 121-123 in order to activate the sequencing logic 104.

In order to define a sequence, the user selects data indicative of an image or list of images from image data 416. The user selects desired images, e.g., return addresses, or recipient addresses, and associates each selected image with a position in the sequence that the user is defining corresponding to a position of a medium on which the image will be printed. In this regard, a location in the sequence corresponds to a position on a particular medium, as is illustrated in FIGS. 2 and 3.

The sequencing logic 104 stores data indicative of each sequence defined, or downloaded, via connection 113, to the device 100 as described hereinabove, as the sequence data 412. Thus, when the user has completed entering data defining a sequence, the sequencing logic 104 generates a sequence corresponding to the sequence data entered by the user and stores the defined sequence as sequence data 412. Note that the image data 416 comprises a plurality of images that may be selected in order to generate a sequence data 416, as described hereinabove. Thus, image data 416 may comprise images of addresses, signatures, objects, emoticons, and the like.

In order to print a sequence, the sequencing logic 104 displays a list of sequence identifiers, via display device 120. The sequence identifiers identify predefined sequences that are stored as sequence data 412. The user selects one of the displayed sequence identifiers from the list via the input device 125 for printing.

The user positions the printing device 100 at a position on the medium and actuates the actuator 102. The sequencing logic 104 detects the actuation, and communicates a currently displayed image to the print head 110 in the order in which the images are located in the selected sequence. Thus, upon first actuation by the user, the sequencing logic 104 communicates the first image in the sequence to the print head 110, and the print head prints the first image. Upon detection of a second actuation, the sequencing logic 104 communicates the second image in the sequence to the print head 110, and the print head 100 prints the second image to the medium. As the user actuates, the logic 104 continues to communicate the next image in the sequence until all the images have been printed.

As described hereinabove, the user does not have to select a next image for printing while printing a sequence. In this regard, the user positions the hand-held printing device 100, actuates the actuator 102, moves the hand-held printing device 100 to the next position, and actuates the actuator 102 again. The sequencing logic 104 automatically communicates the next image to the print head 110 upon detection of actuation. Effectively, the sequencing logic 104 tracks each actuation with each image in the sequence that is to be communicated to the print head 110.

An exemplary interface for the use and operation of the hand-held printing device 100 is described hereafter with reference to FIGS. 5-15.

FIG. 5 depicts the surface 118 (FIG. 1A) comprising the display device 120 and the input device 125. The input device 125 comprises three exemplary input buttons 121-123. The number of buttons may vary in other embodiments of the input device 125. In the exemplary interface in FIG. 5, buttons 121 and 122 are used for a variety of functions further described herein. Buttons 121 and 122 are hereinafter referred to as “scroll buttons.” Furthermore, button 123 activates the printing device 100 and is used for additional functionality as described further herein. The button 123 is hereinafter referred to as the “power button.”

The display device 120 is preferably a liquid crystal display (LCD), however, other types of display devices 120 are possible in other embodiments. The display device 120 comprises a textual “Sequence Off” indicator that indicates that the sequencing logic 104 is currently not activate.

The display device 120 preferably displays a cursor (“>”) 402 that indicates a current working position in a list 408 of selections. The user may use the scroll buttons 121 and 122 to move the cursor through the list 408 to operate the sequencing logic 104 (FIG. 1A).

In one embodiment, the user may depress the up and down scroll buttons 121 and 122 simultaneously to activate the sequencing logic 104. When the scroll buttons 121 and 122 are depressed simultaneously, the “Sequence Off” indicator changes to “Sequence On, as illustrated in FIG. 5. In other embodiments, a sequencing selection may be included in the list, so that the user scrolls to that selection and activates it by depressing the “Power” button. Furthermore, the display device 120 displays a “Select First Image or Sequence” command prompt. The user may then create a new sequence by selecting an image as described further herein, or the user may select an already existing sequence for printing.

In the example, the user has moved the cursor 402 to the “Return Address” entry in the list 408. Therefore, the user desires to define a sequence. If the user desires to select a pre-existing sequence, then the user moves the cursor 402 to the “Stored Sequences” entry and selects the power button 123, as described further herein. Preferably, each entry in the list 408 is indicative of an image file or a directory, i.e., a list of images such that when a directory is selected with the cursor 402, each image in the directory is listed on the display device 120.

In the example provided, the “Return Address” entry is representative of a stored image, e.g., the company address. In order to select the “Return Address,” the user may scroll the cursor 402 to the “Return Address” entry and depress the power button 123.

The sequencing logic 104 displays, via the display device 120, a position indicator 404 that indicates the location, e.g., position 1, 2, 3, 4, 5, or 6, in the sequence for which the user is currently selecting an image, as shown in FIG. 7. Further, the sequencing logic 104 displays the selected image 406, e.g., the image associated with the “Return Address” entry selected by the user, and displays an identifier “IMAGE1,” Indicating that the displayed image is the first image in the sequence. The user may then depress the power button 123 to select the displayed image 406, thereby associating the image 406 with location one of the sequence that the user is currently defining.

The display 120 further comprises a counter 162, which is a graphical symbol that exhibits a number. The number is indicative of the sequential number in the sequence of the currently displayed image. Thus, the counter 162 displays a “1,” which indicates that the image 406 is the first image in the sequence. In this regard, as the user adds images to the sequence, the counter 162 increments to reflect the number of images in the sequence.

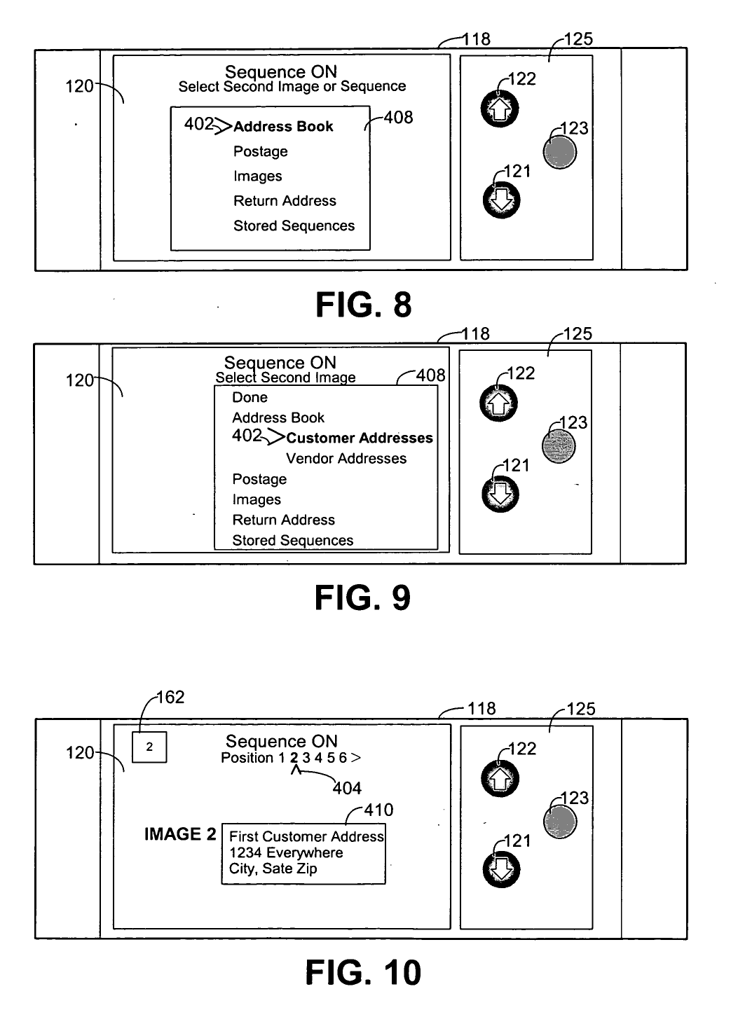

Once the user selects the first image, the sequencing logic 104 changes the display as shown in FIG. 8. In this regard, the sequencing logic 104 displays the list 408 and a “Select a Second Image” command prompt. The user may then move the cursor 402 to one of the entries in the list 408. In this particular example, the user moves the cursor 402 to the “Address Book” entry and depresses the power button 123, which displays the list as illustrated in FIG. 9.

Notably, the “Address Book” entry is related to a directory that comprises a “Customer Addresses” entry and a “Vendor Addresses” entry. In FIG. 9, the user has scrolled to the “Customer Addresses” entry, which is associated with a list of customer address images. The user may then select the “Customer Addresses” entry by depressing the power button 123.

With reference to FIG. 10, the sequencing logic 104 then displays the first image 410 in the selected list, e.g., “Customer Addresses,” to the display device 120. Further, the display device 120 indicates that the image displayed corresponds to the second image selected, i.e., “IMAGE2,” and sequencing logic 104 changes the position indicator 404 to indicate the second position in the sequence. In order to select the list of images for position two in the sequence, the user depresses the power button 123. Note that by selecting the list at location two, location two will be a variable image. For example, for each envelope, “Position two” will vary recipient addresses, as described herein with reference to FIG. 1B.

Furthermore, as described hereinabove with reference to FIG. 7, the display 120 comprises the counter 162. In this regard, the logic 104 increments the counter 162 to indicate that the image 410 currently displayed is the second image in the sequence.

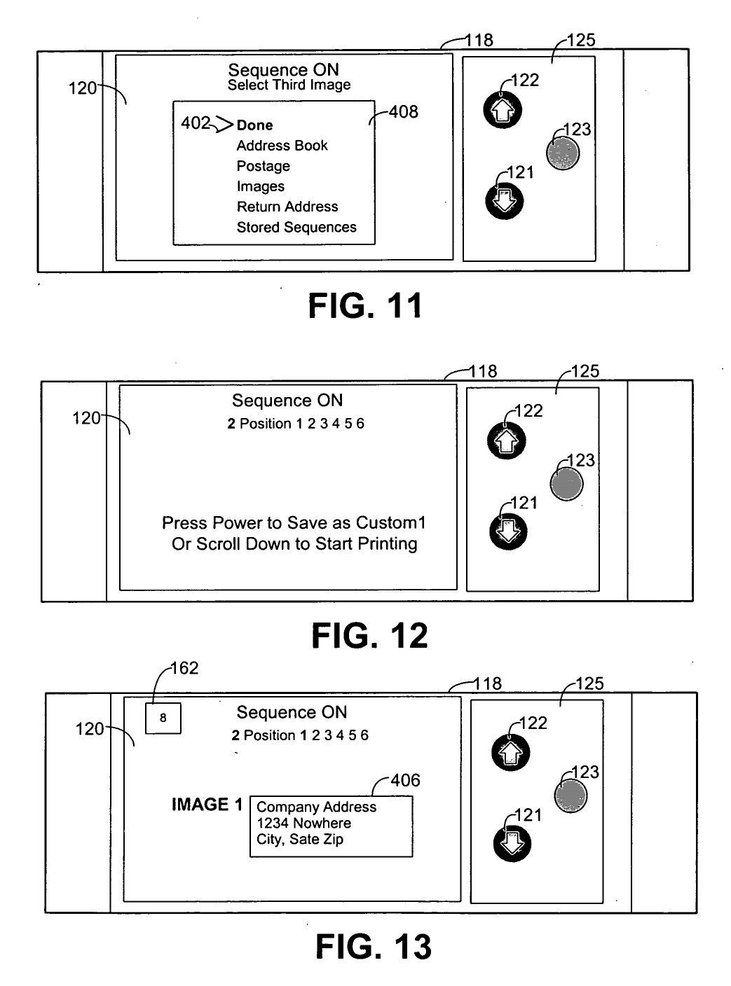

In response to the user depressing the power button 123, the sequencing logic 104 then displays the list 408 as previously described and “Select Third Image” command prompt, as shown in FIG. 11. In the present example, the user has completed generating a list, so the user moves the cursor 402 to the “Done” entry and depresses the power button 123 to complete the sequence definition.

When the user depresses the power button 123, the sequencing logic 104 then generates the data indicative of the defined sequence and stores the defined sequence in sequence data 412, as described hereinabove.

Notably, in addition to the “Address Book,” entry, and the “Return Address” entry, the list 408 displayed by the sequencing logic 104 further comprises a “Postage” entry, an “Images” entry, and a “Stored Sequences” entry. In this regard, the “Postage” entry, when selected, might display different postage amounts, e.g., 0.50 cents or 0.37 cents. The “Images” entry, when selected, might display a plurality of images that the user may select for printing, e.g., signature images. The “Stored Sequences” entry stores previously defined sequences when selected, and is described further herein.

When the user selects the “Done” entry, the sequencing logic 104 displays “attribute data” associated with the sequence. Attribute data refers to data further describing the sequence, for example, data indicative of the number of total positions in the sequence or data identifying the end of the sequence. For example, the display device 120 in FIG. 12 indicates that the defined sequence is a “2 position” sequence.

Furthermore, the sequencing logic 104 displays a direction to the user to “Press Power to Save as Custom1 or Scroll Down to Start Printing.” In this regard, if the user desires to save the sequence, the user selects power button 123. Thus, if the user moves the cursor 402 to the “Stored Sequences” entry in the list 408 in FIG. 11, the “custom1” sequence will now displayed as one of the selections in the list under “Stored Sequences.”

If the user scrolls down in FIG. 12, the sequencing logic 104 displays the attribute data of the sequence being printed, i.e., “2 position,” as shown in FIG. 13. Further, the sequencing logic 104 displays the first image 406 in the sequence.

The user may then position the hand-held printing device 100 on a medium, actuate the actuator 102, and the print head 110 prints the image 406 at the position manually selected by the user. Once the actuator 102 actuates, the sequencing logic 104 displays the second image in the sequence being printed, which would be the first customer address found in the customer address list described hereinabove. The sequencing logic 104 continues until the last image in the sequence has been printed.

In one embodiment, the counter 162, as described hereinabove with reference to FIGS. 7 and 10, displays the total number of images in the sequence. Thus, in the example in FIG. 13, the user has generated and/or selected a sequence for printing that comprises “8” images. For example, the user may desire to print four envelopes, wherein each envelope comprises a return address and a recipient address. FIG. 13 depicts the first image 406 in the sequence. Once the user actuates the actuator 102 (FIG. 1A), the counter 162 decrements to a “7,” indicating that there are seven more images in the sequence to print, and displays the second image (not shown) in the sequence for printing.

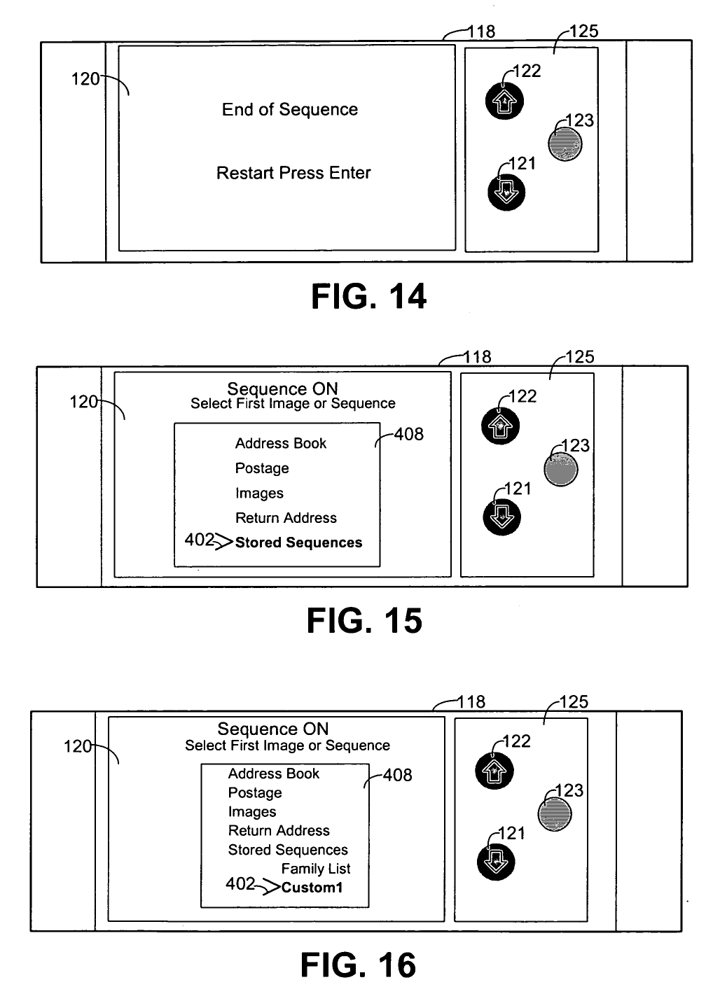

After the last image has been printed, the sequencing logic 104 displays “End of Sequence,” as indicated in FIG. 14. As described hereinabove, the sequence data 412 may comprise data that indicates the end of the sequence.

Throughout printing a sequence of images, the user is able to visually verify that the image printed to the medium is the correct image. In this regard, the user may visually verify each image after each actuation, or the user may wait until each image in the sequence has been printed to verify. If the user determines that an image has not been successfully printed to the medium, then the user may scroll through the sequence of image using the scroll buttons 121 and 122 and reselect the incorrectly printed image for reprint. In this regard, the scroll buttons 121 and 122 enable bi-directional scrolling through the list of images in the sequence.

FIGS. 15 and 16 illustrate selection of a stored sequence for printing. As shown in FIG. 15, the user moves the cursor 402 to the entry “Stored Sequences” and depresses the power button 123. After the user selects “Stored Sequences,” the user may then move the cursor 402 to select the “Custom1” list from the “Stored Sequences” directory.

Once the user has selected a sequence for printing, the first image from the sequence is displayed. Once the user actuates the actuator 102, the sequencing logic 104 communicates the images to the print head 110 in the order in which the user defined the selected sequence.

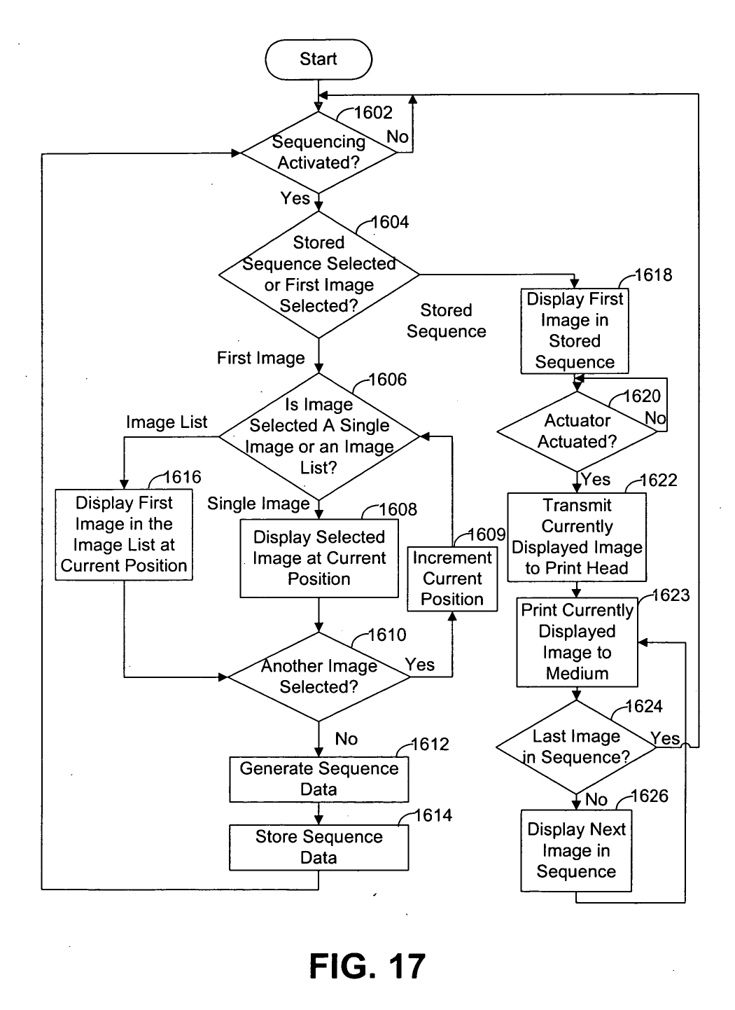

An exemplary architecture and functionality for the use and operation of the hand-held printing device 100 are described hereafter with reference to FIG. 17.

If sequencing is activated in step 1602 and the user desires to create a sequence, then the user selects an image or a list of images from the list 408 (FIGS. 5-15). If the user selects an image or a list of images in step 1604, then the sequencing logic 104 (FIG. 1A) determines if the selection is an image or a list of images in step 1606. If the item selected is an image, then the sequencing logic 104 displays the selected image and the current position within the sequence being generated in step 1608.

If another image is selected in step 1610, then the current position is incremented. Image selection continues until the user does not select another image to add to the sequence in step 1610.

When the user has selected all the images for the sequence, the sequencing logic 104 generates a sequence in step 1612. The sequencing logic 104 then stores the sequence as sequence data 412 (FIG. 3) in step 1614.

With reference to step 1606, if an image selection is a list of images, the sequencing logic 104 displays to the display device 120 (FIG. 1A) the first image in the list and its position in the sequence in step 1616.

A list of images may be, for example, a list of recipient names and corresponding addresses. Such a list may be stored as image data 416 indexed by an identifier, e.g., “Recipient List.” Thus, the user may select “Recipient List” for one of the positions in the sequence. If selected, the sequencing logic 104 displays at the indicated position the first image in the list of images selected.

Note that when a list, e.g., “Recipient List,” is selected for one of the positions in the sequence, the sequencing logic 104 will vary the image printed for the position as the user proceeds from one medium to the next or from one position on the medium to the next. Thus, when a list is selected, such selection indicates a variable image in the sequence.

As described hereinabove with reference to FIG. 3, sequence 300 is an exemplary sequence illustrating a variable image in the sequence. As shown, the varying images, e.g., the Recipient Address images 302, 304, 306, and 308 in the sequence 300 are deliberately interspersed with the static image, e.g., the Return Address 301, 303, 305, and 307, based upon the position the user anticipates for each image on the medium. In this regard, assume that the user defines “Position One” as a return address and “Position Two” as a list of recipients. The sequence generated will comprise a return address, a first recipient address, the return address, a second recipient address, the return address, a third recipient address, etc. Notably, the return address is static in the sequence, and the recipient address varies.

In addition to enabling the user to generate defined sequences, the sequencing logic 104 also enables a user to print stored sequences. If the user selects “Stored Sequences” from the list 408 (FIG. 15) in step 1604 and the user selects a particular stored sequence from the list, e.g., “Custom1,” then the sequencing logic 104 displays the first image in the sequence data associated with the selected sequence, e.g., “Custom1,” to the display device 120 in step 1618.

The user then positions the printing device 100 and actuates the actuator 102, as described hereinabove. When the actuator 102 is actuated in step 1620, the sequencing logic 104 communicates the currently displayed image to the print head 110 in step 1622, and the print head 110 prints the currently displayed image to the medium, in step 1623. If it is not the last image in the sequence in step 1624, then the sequencing logic 104 displays the next image in the sequence in step-1626 and waits for actuation in step 1620. This process repeats until the end of the sequence is detected in step 1620.

Note that the device 100 may further comprise a speaker device (not shown) such that the sequencing logic 104 may provide audible feedback to the user of the device 100 alone or in combination with the displayed data as the sequence is updated. For example, after the print head 110 has printed an image and the logic 104 is displaying the next image to the display device 120, the sequencing logic 104 may transmit data to the speaker device indicative of the audible sounds “position two recipient address.”

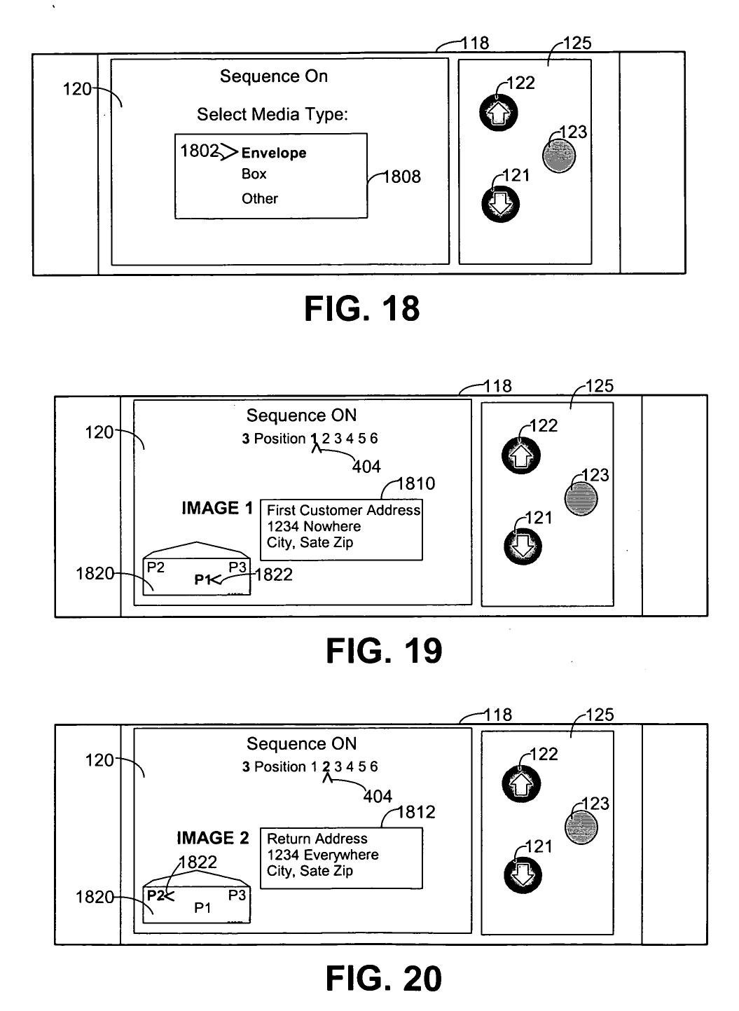

FIGS. 18-21 depict another embodiment of the printing device 100 of the present disclosure. In such an embodiment, the display 120 further comprises a graphic 1820 that depicts a type of media to which the images will be printed.

In this regard, in generating a sequence, as described with reference to FIGS. 6-11, the user defines positions corresponding to the selected media. Thus, with reference to FIG. 18, if the user desires to generate a sequence and selects the “Return Address” entry in FIG. 6, the sequencing logic 104 can display a list 1808 that comprises entries associated with types of media, for example envelopes, boxes, or other types of media. The user may then move a cursor 1802 throughout the list 1808 and depress the power button 123 in order to select the medium for which the user desires to generate a sequence. The user then generates a sequence as described herein with reference to FIGS. 6-11.

With reference to FIG. 19, the logic 104 can display a graphic 1820 representative of the desired media as selected with reference to FIG. 18. The logic 104 may then move a cursor 1822, as the user generates the sequence that identifies the position for which the user is currently defining an image or list of images.

Once the user defines such a sequence and selects such a sequence from the list of entries 408 illustrated in FIG. 16, the logic 104 then displays the first image to be printed as indicated by “IMAGE1” and by the cursor 1822 on the graphic 1820 in FIG. 19. For the exemplary defined sequence, the first image to be printed is a customer address image 1810.

Once the user actuates the device 100, the logic 104 then displays the next image for printing as shown in FIG. 20. In this regard, the logic then displays the return address 1812. In addition to moving the cursor 404 to position 2, the logic 104 also moves cursor 1822, which graphically indicates the position “P2” currently ready for printing.

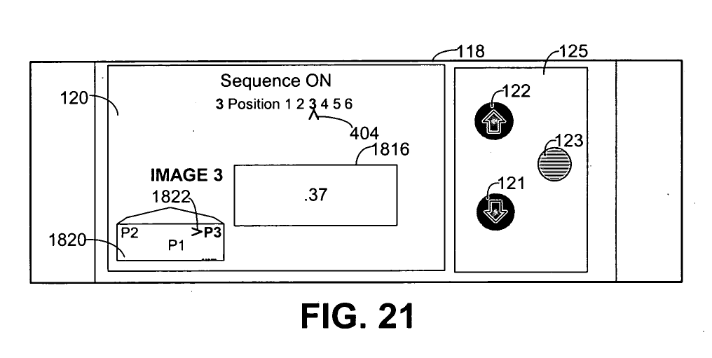

Once the user actuates the device 100, the logic 104 then displays the next image for printing as shown in FIG. 21. In this regard, the logic then displays the postage 1816. In addition to moving the cursor 404 to position 3, the logic 104 also moves cursor 1822, which graphically indicates the position “P3” currently ready for printing.

Note that during operation, the user may at any time use the scroll buttons 122 and 121 to scroll throughout a sequence and its various positions. Furthermore, as the user scrolls through a sequence, the logic 104 may graphically indicate the currently selected position with reference to the associated media by moving the cursor 1822 as the user scrolls.

In one embodiment of the present disclosure, the device 100 (FIG. 1A) may further comprise an input device (not shown), e.g., a barcode scanner. Thus, when the user (not shown) is defining a sequence, the user may use an input received from the input device as a first position in the sequence, e.g., a scan of a barcode is the first position in the sequence. The sequence may then further be defined by addition positions, e.g., one or more positions to which the device may print an image to a medium.

1. A hand-held printing device, comprising:
a hand-operated mechanical actuator for moving a print head that prints images to a medium;
memory configured to electronically store a sequence of images; and
logic configured to detect a first actuation of the actuator and automatically communicate a first image in the sequence to the print head, the logic further configured to detect a second actuation of the actuator and automatically communicate a second image in the sequence to the print head.

2. The printing device of claim 1, wherein the logic is further configured to detect actuation of the actuator and print each image in the sequence of images in a predetermined sequential order.

3. The printing device of claim 1, wherein the sequence is stored in memory in a predetermined sequential order.

4. The printing device of claim 1, further comprising an input device, the logic configured to receive data defining the sequence from a user via the input device.

5. The printing device of claim 4, wherein the input device comprises a keypad.

6. The printing device of claim 4, wherein the input device comprises a port communicatively coupled to the hand-held device, the port configured to receive the sequence from a computing device.

7. The printing device of claim 4, wherein the logic is further configured to display a media type selection list to the user and receive data from the user indicative of the type of media on which the defined sequence is to be printed.

8. The printing device of claim 1, further comprising a display device, wherein the logic is further configured to display to the display device a list comprising an indicator indicative of the first sequence and an indicator indicative of a second sequence.

9. The printing device of claim 1, wherein the printing device is configured to receive data indicative of a sequence from a computing device, the sequence comprising the first image and the second image.

10. The printing device of claim 9, wherein the logic is configured to store the received data in memory and print the sequence if selected by a user.

11. The printing device of claim 1, wherein the printing device is configured to receive image data from a computing device, the image data indicative of the first image and the second image.

12. The printing device of claim 1, wherein the sequence comprises a plurality of images corresponding to a unique position on the media.

13. The printing device of claim 12, wherein an image selected for the unique position comprises static data, incremental data, or dynamic data.

14. The printing device of claim 1, wherein the logic is further configured to display a list of unique identifiers indicative of each image in the sequence.

15. The printing device of claim 14, wherein the logic is further configured to enable scrolling through the list of unique identifiers such that a user can select an image for printing to the media.

16. The printing device of claim 1, wherein each image in the sequence corresponds to a respective plurality of positions on a particular medium.

17. The printing device of claim 1 further comprising an input device, the input device comprising a bi-directional scroll enabling a user to scroll through the images in the sequence.

18. The printing device of claim 17, wherein the logic is further configured to reprint an image based upon an input via the bi-directional scroll.

19. A hand-held printing device, comprising:
a hand-operated actuator; and
an ink jet print head that is activated with the actuator;
means for detecting a first actuation of the actuator;
means for activating the print head to print a first image of a sequence of images when a first actuation is detected;
means for detecting a second actuation of the actuator; and
means for activating the print head to print a second image of the sequence of images.

20. A system for printing, comprising:
a computing device configured to store data indicative of a sequence of images in a predetermined sequential order;
a hand-held printing device communicatively coupled to the computing device comprising an actuator for activating a print head that prints images to a medium, the hand-held printing device further comprising logic configured to detect a first actuation of the actuator and automatically retrieve a first image in the sequence from the computing device and communicate the first image to the print head, the logic further configured to detect a second actuation of the actuator and automatically retrieve a second image in the sequence from the computing device and communicate the second image to the print head.

21. A method, comprising the steps of:
receiving an input indicative of a first sequence of images to be printed in a predetermined sequential order;
detecting a first manual actuation of a hand-operated actuator;
printing a first image of the first sequence to a medium in response to the detecting of the first actuation;
detecting a second manual actuation of the hand-operated actuator; and
printing a second image of the first sequence to the medium in response to the detecting of the second actuation.

22. The method of claim 21, further comprising defining the first sequence as the first image and the second image.

23. The method of claim 22, wherein defining the first sequence comprises defining the first sequence via an input device.

24. The method of claim 23, further comprising storing the first sequence in memory.

25. The method of claim 21, further comprising displaying to a display device an indicator indicative of the first sequence and a second sequence.

26. The method of claim 21, further comprising defining a plurality of sequences, each sequence defined having an identifier.

27. The method of claim 26, further comprising displaying a list comprising each sequence identifier.

28. The method of claim 27, further comprising receiving an input indicative of one of the identifiers listed in the displaying step.

29. The method of claim 21, further comprising reprinting the first image of the first sequence to a medium in response to detecting a third actuation based upon a user input.

30. A printing method, comprising:
storing a plurality of images in a predetermined sequential order, wherein a first a portion of the images are substantially similar and another portion of the images varies and each of the varying images is separated by one of the substantially similar images;
printing the plurality of images such that each of the substantially similar images is printed between at least two varying images in the sequential order in response to manual actuation of a hand-held printer.
